(19) United States
(12) Patent Application Publication
(10) Pub. No.: US 2022/0022550 A1
(43) Pub. Date: Jan. 27, 2022

(54) Electronic Cigarette, Consumable For Electronic Cigarette, Smoking System And Method

(71) Applicant: JT International S.A., Geneva (CH)

(72) Inventors: Timothy Giles Beard, Cambridge (GB); Matthew John Lawrenson, Chesterfield, MO (US)

(73) Assignee: JT International S.A., Geneva (CH)

(21) Appl. No.: 17/427,366

(22) PCT Filed: Mar. 18, 2020
(86) PCT No.: PCT/EP2020/000072

§ 371 Date: Jul. 30, 2021

(30) Foreign Application Priority Data
Mar. 19, 2019 (EP) 19163700.8

(51) Int. Cl. A24F 40/57; A24F 40/46; A24F 40/42; A24F 40/53; A24F 40/10

(52) U.S. Cl. CPC A24F 40/57; A24F 40/46; A24F 40/10; A24F 40/53; A24F 40/42

(57) ABSTRACT

An electronic cigarette includes a main body having a receiving cavity configured to receive a removable consumable including a substance to be vaporized, and an electrical circuitry, wherein the electrical circuitry includes a heating circuit that is connectable to a heater configured to supply energy to the consumable such as to vaporize the substance, and wherein the electrical circuitry further includes an open control circuit including and connected to at least two electrical contact points arranged as a pair and configured to establish a closed electrical circuit when they are in contact with a conductive surface on the removable consumable, the conductive surface being separate from the heater. The open control circuit includes a plurality of closable branches, wherein each branch of the open control circuit is provided with a pair of electrical contact points. The electrical circuitry further includes a controller.

### FIELD OF THE INVENTION

The present invention relates to an electronic cigarette, a consumable for an electronic cigarette, an electronic smoking system and to a method of operating an electronic smoking system.

### BACKGROUND OF THE INVENTION

The term electronic cigarette, or e-cigarette, is usually applied to a handheld electronic device that simulates the feeling or experience of smoking tobacco in a traditional cigarette. Commonly cigarettes work by heating an aerosol-generating liquid to generate the aerosol that forms a vapour, which is then inhaled by the user.

Accordingly, using e-cigarettes is sometimes also referred to as “vaping”. The aerosol-generating liquid in the electronic cigarette usually comprises nicotine, propylene glycol, glycerin and flavourings. Apart from liquids, also other types of consumables are used in electronic cigarettes such as, for example, tobacco that is subjected to a heat-not-burn procedure.

One important characteristic of the electronic cigarette is a temperature to which the consumable is heated to generate the aerosol. This temperature is also referred to as a “vaping temperature”. The vaping temperature can have a significant impact on the users vaping experience for multiple reasons. Excessive heating can change, in particular negatively, the taste of the vapour, increase the temperature of the inhaled vapour to an uncomfortable level, cause faster consumption of the consumable, in particular of the aerosol-generating liquid, and may cause more rapid degradation of the components of the electronic cigarette.

With the growing popularity of electronic cigarettes, also the number of available types of consumables continues to increase. Achieving accurate temperature control can prove difficult for users. Some existing electronic cigarettes offer manual temperature control; this, however, requires the user to know up to which temperature the consumable should be heated. Given the large variety of compounds and flavours that make up consumables of electronic cigarettes, the specific value can be very difficult to identify and can require a time-consuming process of trial and error on the part of the user.

US 2016 021 930 A1 describes an electronic cigarette into which a cartridge is insertable. An electromechanical interface connection may convey a resistance measurement from the cartridge to the electronic cigarette. The resistance measurement conveyed from the cartridge may serve to modulate activation parameters of the electronic cigarette such as a peak activation temperature.

US 2015 0128971 A1 describes an electronic cigarette that includes a shell and a cartomizer receivable within a chamber within a portion of the shell. A connector may be provided to make electrical contact to electrical circuitry of the cartomizer inserted into the electronic cigarette. The connector may include a controlling pin used to detect variations in voltage drop across the pin when connected to various types of cartomizers. Depending on different voltage drops, the type of the cartomizer may be identified.

U.S. Pat. No. 9,408,416 B2 describes a device for generating an inhalable aerosol comprising a temperature regulator. A resistive heating element and thermistor are provided to monitor and precisely control the vaporisation temperature.

The prior art documents cited in the foregoing either do not allow to regulate the heating temperature of the electronic cigarette specifically depending on a type of consumable inserted into the electronic cigarette or do so in a comparatively error-prone way. It is known that voltage measurements and resistance measurements are temperature-dependent and so the measuring of a voltage drop or a resistance value of a consumable that is inserted into an electronic cigarette and will necessarily be heated or be situated close to a heating element may be less reliable than desired. The temperature of the consumable before it is inserted into the electronic cigarette may introduce undesirable errors into the measurements and this may lead to an incorrect vaping temperature.

### SUMMARY OF THE INVENTION

In view of the above, it is an objective of the present invention to provide an electronic cigarette, a corresponding consumable, a smoking system and a method that allow precisely determining at least one operating parameter, in particular an optimal vaping temperature, for a consumable from the consumable itself in a robust and error-proof way.

It would also be advantageous to provide an authentication method in which an electronic cigarette, or an electronic smoking system, only operates when a specific type of consumable is used with the electronic cigarette.

The present invention solves at least the above-described problem by realising the detection of a certain type of consumable, for example a cartridge, based on a mechanical arrangement of electrical contact points of the electronic cigarette and corresponding electrically conductive patterns arranged at the consumable that indicate or encode operating parameters of the consumable, for example, an optimal heating temperature.

The invention provides an electronic cigarette with the features as set out in claim 1, an electronic smoking system with the features as set out in claim 12 and a method of operating an electronic smoking system with the features as set out in claim 17.

Accordingly, the invention provides, according to a first aspect, an electronic cigarette comprising:

a main body having a receiving cavity configured to receive a removable consumable (150) comprising a substance to be vaporized, and
an electrical circuitry,
wherein the electrical circuitry comprises a heating circuit that is connectable to a heater configured to supply energy to the consumable such as to vaporize the substance, and
wherein the electrical circuitry comprises an open control circuit comprising and connected to at least two electrical contact points arranged as a pair and configured to establish a closed electrical circuit when they are in contact with a conductive surface on the removable consumable, the conductive surface being separate from the heater.

The heater may comprise a plurality of individual heating elements.

In the following, advantageous features of embodiments are described. It should be understood that any or all of these features may, if not explicitly stated otherwise, refer to one and the same embodiment. In other words, features described in the following may be freely combined or used as variants of one another.

In some advantageous embodiments, refinements or variants, the at least two electrical contact points are located inside the receiving cavity. In this way, the electrical contact points are protected from external influences, and the conductive surface can be provided in such a way on the removable consumable that it is completely covered by the main body when the consumable is completely inserted into the receiving cavity.

In some advantageous embodiments, refinements or variants, the heating circuit and the control circuit are connected in series. In other advantageous embodiments or variants, the heating circuit and the control circuit are connected in parallel.

In some advantageous embodiments, refinements or variants, the open control circuit comprises a plurality of closable branches. More preferably, each branch of the open control circuit is provided with a pair of electrical contact points. In other words, different ones of the closable branches are closed depending on which pair of electrical contact points is electrically connected by an electrically conductive element.

It should be understood that a closable branch is arranged in particular such that an electrically conductive element (such as an electrically conductive surface) can close the branch, preferably at the pair of electrical contact points, so as to complete a (and thus generated a closed) electrical circuit.

In some advantageous embodiments, refinements or variants, a first electrical contact point and a second electrical contact point within each pair are provided at the same longitudinal position in the receiving cavity, and the plurality of pairs are provided at different positions in the longitudinal direction of the receiving cavity. In this way, electrically conductive elements with an extension perpendicular to the longitudinal direction of the receiving cavity may be configured such as to connect the electrical contact points of one, and only of a single one, of the pairs of electrical contact points.

In some advantageous embodiments, refinements or variants, the branches of the electrical control circuit are realized as heating circuits, wherein the heating circuits deliver electrical energy (or: electrical current) to heating elements based on an electrical resistance of the respective heating circuit. In other words, a certain electrical resistance of each heating circuit at a specific time may determine how much electrical current is provided to a respective heating circuit. Thus, effects that change the electrical resistance, for example temperature changes, can be used to indirectly control how much electrical current is provided to the heating circuits.

In some advantageous embodiments, refinements or variants, the control circuit comprises, set within each of its branches, at least one positive temperature coefficient, PTC, thermistor. Preferably, each PTC thermistor has a different Curie temperature. Since the resistance of the thermistors rises strongly at the Curie temperature, this may be used to realize that each heating circuit essentially, or completely, stops to provide electrical energy to the heater (or to a specific heating element of the heater) after the heating circuit itself has reached its corresponding Curie temperature. This realizes a simple yet efficient regulation of the temperature of the heating circuit to its Curie temperature.

Thus, more preferably, each PTC thermistor is arranged to be subject to heat when the consumable is being heated by the heater such that the electrical resistance of the respective heating circuit depends on the temperature to which the consumable is heated.

In some advantageous embodiments, refinements or variants, the heater is located within the consumable.

In some advantageous embodiments, refinements or variants, the heater is located in the main body of the electronic cigarette, preferably within the receiving cavity. In this way, the consumable can be produced cheaper.

In some advantageous embodiments, refinements or variants, the electrical circuitry further comprises a controller, wherein the controller is configured to sense which pair of electrical contact points is connected by a conductive surface on the consumable. The controller is preferably further configured to set an operating temperature to which the heater heats a portion of the consumable based on which pair of the electrical contact points is connected. In other words, the regulation achieved in some of the above-described embodiments using the Curie temperature of heating circuits exposed to heat when the heater is active, can in these embodiments, refinements or variants be achieved digitally.

Instead of, as previously described, simply activating the heater until the rise of resistance with the Curie temperature temporarily blocks the electrical energy (until the heating circuit has slightly cooled), in these variants there is preferably a temperature sensor provided to provide the feedback for the digital regulation.

In some advantageous embodiments, refinements or variants, the controller is configured to set different heating profiles, according to which the heater heats the portion of the consumable. Each heating profile may comprise a temporal sequence of desired operating temperatures.

According to a second aspect, the invention provides a consumable for an electronic cigarette (preferably for an electronic cigarette according to an embodiment of the first aspect), the consumable comprising a vaporizable substance and a housing, wherein the housing is provided with an electrically conductive pattern configured to close an open control circuit in (or: of) the electronic cigarette when contacted by a pair of at least two electrical contact points (which are electrically connected to the open control circuit) in the electronic cigarette.

This advantageously allows, when the electronic cigarette is configured according to an embodiment of the first aspect, encoding information about the type of consumable (e.g. properties of a content of the consumable such as a type of content, an amount of content and/or the like) and/or instructions for controlling the electronic cigarette in a way recommended for that particular consumable (e.g. comprising an optimal operating temperature for that particular consumable) in the way and geometric shape the electrically conductive pattern is arranged at, in, or on, the housing of the consumable.

In some advantageous embodiments, refinements or variants, the electrically conductive pattern is a continuous pattern which enables the consumable to close the open control circuit irrespectively of the angular position of the consumable in relation to the receiving cavity. In particular, the electrically conductive pattern may be formed in the shape of a straight line arranged on a flat, or on a curved, surface of the housing of the consumable.

In some advantageous embodiments, refinements or variants, the electrically conductive pattern is formed in the shape of a ring (i.e. as an electrically conductive ring pattern), positioned around the circumference of the consumable. In this way, regardless of how far the consumable is rotated along a longitudinal axis thereof, some part of the electrically conductive ring pattern will always connect two electrical contact points of the electronic cigarette that are arranged perpendicularly to said longitudinal axis. This makes the smoking system comprising the electronic cigarette and the consumable very easy to use as a user does not have to spend a lot of time finding the exact arrangement required when inserting the consumable into the receiving cavity of the electronic cigarette. Instead, aligning the longitudinal axis of the consumable (to which the electrically conductive ring pattern is arranged perpendicularly) with a longitudinal axis of the receiving cavity of the electronic cigarette is sufficient as no axial turning or fine-tuning is necessary.

In some advantageous embodiments, refinements or variants, the electrically conductive pattern is at least partially printed onto an outer layer of the consumable. In this way, the consumable can be produced comparatively cheaply, and a large variety of different shapes for the electrically conductive pattern can be realized. Preferably, the electrically conductive pattern is printed using an ingredient selected from the group comprising graphene and metallic nanoparticle ink. The inventors have found that these ingredients provide an electrically conductive pattern (e.g. in ring shape) with excellent conductive properties while still being resilient under external influences.

According to a third aspect, the invention provides an electronic smoking system comprising an electronic cigarette according to an embodiment of the first aspect and a consumable according to an embodiment of the second aspect.

According to a fourth aspect, the invention provides a method of operating an electronic smoking system (in particular an electronic smoking system according to an embodiment of the third aspect), the smoking system comprising an electronic cigarette (preferably according to an embodiment of the first aspect) and a consumable (preferably according to an embodiment of the second aspect) including an electrically conductive pattern provided at least partially on an outside of the consumable, the method comprising the steps of:

inserting the consumable into a receiving cavity of the electronic cigarette,
contacting, by the electrically conductive pattern, at least one pair of electrical contacts of the receiving cavity of the electronic cigarette, thereby closing at least one of different branches of a control circuit of the electronic cigarette; and
heating, by a heater of the electronic cigarette, at least a portion of the consumable according to a heating profile, the heating profile being selected based on which one of the branches of the control circuit of the electronic cigarette has been closed.

The method according to the fourth aspect is also a method for authenticating a consumable in that the electronic cigarette (and, accordingly, the electronic smoking system) only operates when a specific type of consumable is inserted into the receiving cavity, namely a consumable that is configured such that its electrically conductive pattern closes at least one of the different branches of the control circuit of the electronic cigarette.

### BRIEF DESCRIPTION OF THE DRAWINGS

For a more complete understanding of the invention and the advantages thereof, exemplary embodiments of the invention are explained in more detail in the following description with reference to the accompanying drawing figures, in which like reference characters designate like parts and in which:

FIG. 1 is a schematic view of an electronic cigarette, a consumable and a smoking system according to embodiments of the invention in a first situation;

FIG. 2 is a schematic view of the electronic cigarette, the consumable and the smoking system of FIG. 1 in a second situation;

FIG. 3 is a schematic view of an electronic cigarette and a smoking system according to other embodiments of the present invention;

FIG. 4 is a schematic flow diagram illustrating a method of operating a smoking system according to a fourth aspect of the present invention.

The accompanying drawings are included to provide a further understanding of the present invention and are incorporated in and constitute a part of this specification. The drawings illustrate particular embodiments of the invention and together with the description serve to explain the principles of the invention. Other embodiments of the invention and many of the attendant advantages of the invention will be readily appreciated as they become better understood with reference to the following detailed description.

It will be appreciated that common and/or well understood elements that may be useful or necessary in a commercially feasible embodiment are not necessarily depicted in order to facilitate a more abstracted view of the embodiments. The elements of the drawings are not necessarily illustrated to scale relative to each other. It will further be appreciated that certain actions and/or steps in an embodiment of a method may be described or depicted in a particular order of occurrences while those skilled in the art will understand that such specificity with respect to sequence is not actually required. It will also be understood that the terms and expressions used in the present specification have the ordinary meaning as is accorded to such terms and expressions with respect to their corresponding respective areas of inquiry and study, except where specific meanings have otherwise been set forth herein.

### DETAILED DESCRIPTION OF EMBODIMENTS

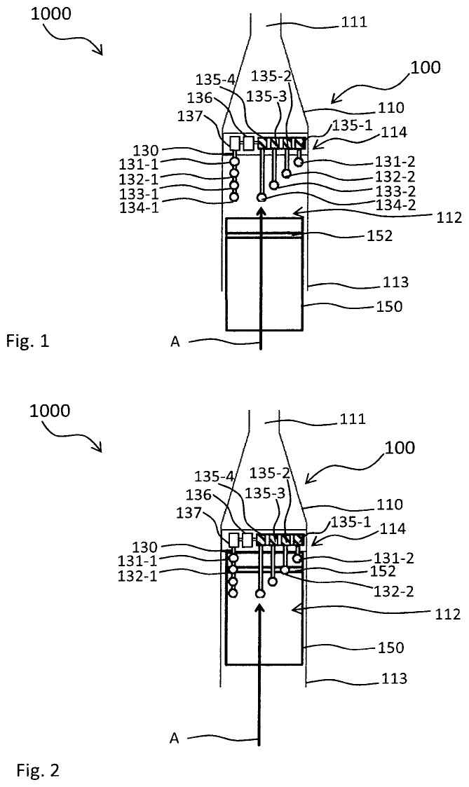

With reference to FIG. 1 and FIG. 2 of the drawings, an electronic cigarette 100 according to an embodiment of the first aspect of the present invention, a consumable 150 according to an embodiment of the second aspect of the present invention and a smoking system 1000 according to an embodiment of the third aspect of the present invention are described.

The system 1000 comprises both the electronic cigarette 100 and the consumable 150. FIG. 1 shows a state in which the consumable 150 is currently being inserted into the electronic cigarette 100, and FIG. 2 shows a state in which the consumable 150 has been fully and correctly received in the electronic cigarette 100.

The electronic cigarette 100 comprises a main body 110 which may be formed in an elongated shape as shown in FIG. 1. The main body 110 comprises a mouthpiece 111, through which an aerosol formed by the electronic cigarette 100 can be inhaled.

The main body 110 further comprises an opening 113 leading into a receiving cavity 112. Through the opening 113 a consumable 150, for example a cartridge 150 or another type of container containing an aerosol-generating liquid or another active ingredient may be inserted into the receiving cavity 112, in particular in a releasably locked way.

The electronic cigarette 100 further comprises electrical circuitry 114. The electrical circuitry 114 includes a control circuit 130 configured to control at least one operating parameter, preferably a heating profile according to which the consumable 150, or at least a portion of the consumable 150, is heated during smoking (i.e. during use of the electronic cigarette 100).

The control circuit 130 comprises at least one pair, preferably a plurality of, pairs of electrical contact points 131-i, 132-i, 133-i, 134-i which are configured to establish electrical contact with a conductive surface portion, in particular with an electrically conductive pattern 152, of the consumable 150. The electrical contact points 131-i, 132-i, 133-i, 134-i are preferably arranged inside the receiving cavity 112 such that, when the consumable 150 is inserted (and preferably releasably locked) within the receiving cavity 112, the electrical contact points 131-i, 132-i, 133-i, 134-i engage with the electrically conductive pattern 152, i.e. at least one electrical connection is created.

In the embodiment of FIG. 1, the electrical circuitry 114 comprises four pairs of electrical contact points: a first pair having a first electrical contact point 131-1 and a second electrical contact point 131-2, a second pair having a first electrical contact point 132-1 and a second electrical contact point 132-2, a third pair having a first electrical contact point 133-1 and a second electrical contact point 133-2 and a fourth pair having a first electrical contact point 134-1 and a second electrical contact point 134-2. Preferably, each contact point is only part of one pair of contact points. In other alternatives, however, one or more contact points may be shared by two or more pairs.

As shown in FIG. 1, the pairs of electrical contact points 131-i, 132-i, 133-i, 134-i are arranged such that different pairs of the electrical contact points 131-i, 132-i, 133-i, 134-i are engaged by differently shaped and/or differently positioned electrically conductive patterns 152. Specifically, in the embodiment shown in FIG. 1, the electrical contact points of each pair of electrical contact points 131-i, 132-i, 133-i, 134-i are arranged at the same longitudinal distance from the opening 113, whereas the pairs are arranged at different longitudinal distances from the opening 113.

In other words, each first electrical contact point 131-1, 132-1, 133-1, 134-1 of each pair is arranged at the same longitudinal distance from the opening as the corresponding second electrical contact point 131-2, 132-2, 133-2, 134-2, whereas each first electrical contact point 131-1, 132-1, 133-1, 134-1 is arranged at a different longitudinal distance from the opening 113 from each other first electrical contact point 131-1, 132-1, 133-1, 134-1, and each second electrical contact point 131-2, 132-2, 133-2, 134-2 is arranged at a different longitudinal distance from the opening 113 than each other second electrical contact point 131-2, 132-2, 133-2, 134-2.

As will become evident in the following, other arrangements of electrical contact points 131-i, 132-i, 133-i, 134-i are possible and may be advantageous. For example, all pairs of electrical contact points may have the same first electrical contact point 131-1, whereas the second electrical contact points 131-2, 132-2, 133-2, 134-2 are arranged at different longitudinal distances from the opening 113 as described in the foregoing.

Referring again to FIG. 1, the electrically conductive pattern 152 of the consumable 150 is formed as an electrically conductive strip, preferably as an electrically conductive ellipsis, in particular a circle, circling the circumference of the consumable 150, more preferably as an electrically conductive circle circling the circumference of the consumable 150.

The electrically conductive pattern 152 is preferably formed only on the outer surface of the consumable 150, where it is easily applied during production of the consumable 150. More preferably, the electrically conductive pattern 152 is printed onto the outer surface of the consumable 150 or onto a material that is, during production of the consumable 150, going to be shaped such as to form the outer surface of the consumable 150, e.g. on a sheet or piece of paper.

Advantageously, electrically conductive ink can be used for printing the electrically conductive pattern 152, preferably graphene-based ink or nanoparticle ink, more preferably silver nanoparticle ink.

The electrically conductive pattern 152 may have only one continuous conductive surface portion or may comprise more than one separate conductive portions, for example to connect more than one pair of electrical contact points. More than one separate conductive portions on the surface of the consumable 150 may or may not be electrically connected within the consumable 150, wherein additional electronic components such as sensors, resistors, heaters, power sources and the like may be connected between such separate but electrically connected conductive portions.

In particular when the electrical contact points 131-i, 132-i, 133-i, 134-i are arranged as described with respect to FIG. 1, it is preferred that consumable 150 is formed, at least in a portion of the consumable 150 comprising the electrically conductive pattern 152, rotationally symmetrically around a rotational symmetry axis A that is parallel to the direction of insertion of the consumable 150 into the opening 113 and/or the receiving cavity 112.

More preferably, the consumable 150 is formed completely rotationally symmetrically along said rotational symmetry axis A and/or the receiving cavity 112 is formed rotationally symmetrically along the same rotational symmetry axis A. This has the advantage that it does not matter how the consumable 150 is rotated along the axis A when it is inserted into the receiving cavity 112 which greatly simplifies the handling of the consumable 150 by the user.

Preferably, the electrically conductive pattern 152 is realized as an electrically conductive ring circling the outer surface of the consumable 150, wherein the electrically conductive ring is arranged in parallel to a virtual plane to which the rotational symmetry axis A is perpendicular. In this way, it also does not matter how the consumable 150 is rotated when it is inserted into the receiving cavity 112: the electrically conductive pattern 152 will always establish an electrical connection with both electrical contact points of any pair of electrical contact points that is arranged at such a distance from the opening 113 that said pair and the electrically conductive pattern 152 are at the same longitudinal position when the consumable 150 is correctly inserted into the receiving cavity 112.

That the consumable 150 is arranged at the correct longitudinal position as a result of being inserted into the receiving cavity 112 may be achieved by way of an engaging portion of the receiving cavity 112 (or of the main body 110) which eventually stops the movement of the consumable 150 into the receiving cavity 112. Whenever in the foregoing or in the following the distance from the opening 113 is mentioned, it should be understood that instead also the distance from said engaging portion may be used instead as a measurement of the longitudinal position of any element.

FIG. 2 illustrates how the consumable 150 is designed and provided such that, as an example, when it is inserted fully and correctly into the receiving cavity 112, the electrically conductive pattern 152 formed as an electrically conductive ring engages the first and the second electrical contact points 132-1, 132-2 of the second pair of electrical contact points.

From the foregoing, it is evident that different consumables 150 may be provided with electrically conductive pattern 152 at different locations and/or having different shapes such that different pairs of electrical contact points 131-i, 132-i, 133-i, 134-i are electrically connected by the electrically conductive pattern 152 when the consumable 150 is inserted into the receiving cavity 112. Specifically with respect to the embodiment shown in FIG. 1, if the electrically conductive pattern 152 were e.g. provided closer to a front end of the consumable 150 with which the consumable 150 is inserted into the receiving cavity 112, then the electrically conductive pattern 152 could engage with the first and second electrical contact points 131-1, 131-2 of the first pair of electrical contact points.

Thus it is possible to encode information in the position of the electrically conductive pattern 152 on the consumable 150. The encoded information may then be decoded by a controlling structure that is configured to control a heater 136 for heating the consumable 150 or a portion thereof. The decoding may be realized, as in the embodiment of FIG. 1, in an electromechanical way, but may additionally, or alternatively, also be realized in a digital way, as will be described with respect to FIG. 4 hereafter.

With respect to FIG. 1, it is further illustrated that the control circuit 130 is open and is only closed, or closable, when both electrical contact points of at least one of the pairs of electrical contact points are engaged by the electrically conductive pattern 152. Depending on the design and arrangement of the electrically conductive pattern 152, different branches or parts of the control circuit 130 may be closed, or closable, when the consumable 150 is inserted into the receiving cavity 112. Preferably, each pair of electrical contact points may be configured to close a different closable branch of the control circuit 130.

Hence, in order to operate the smoking system 1000, a pair of the electrical contact points need to be connected to the electrically conductive pattern to close at least one branch of the control circuit 130. This has a further advantage that only consumables with a particular conductive pattern enable the use of the electronic cigarette 100. This will allow the electronic cigarette 100 to provide an authentication of the consumable 150.

It should be understood that the electronic cigarette 100 may be provided with a user interface comprising e.g. an ON/OFF control (such as an ON/OFF switch) and that the control circuit 130 is preferably only closable when the ON/OFF control is in the ON position and is not closable when the ON/OFF control is in the OFF position. In the following the invention will be further described without mentioning the ON/OFF control; whenever it is described that a circuit is closable or closed, this is meant to be understood as pertaining to the case when the ON/OFF control is in the ON position for embodiments that comprise an ON/OFF control.

The control circuit 130 is connected to, or arranged as, a heating circuit that provides electrical energy to a heater 136 configured to heat at least a portion of the consumable 150 such as to generate the aerosol. The heater 136 may be arranged within the main body 110, as shown in FIG. 1, or within the consumable 150. In the latter case, the heater may be electrically coupled between two separate conductive portions of the electrically conductive pattern 152.

In the described embodiment the heater 136 is configured such that a temperature to which the heater 136 is adapted to heat the portion of the consumable 150 (“vaping temperature” or “operating temperature”) is controlled by the electrical current running through the heater 136. The heater 136 may e.g. be realized as an Ohmic heating element.

Each closable branch of the control circuit 130 preferably comprises a different temperature-dependent total electrical resistance and is configured to supply, when closed by the electrically conductive pattern 152, the heater 136 with electrical energy. An electrical power source 137 for supplying said electrical energy, when the control circuit 130 is closed, may be arranged within the consumable 150 and/or within the main body 110, as illustrated in FIG. 1.

The closable branches of the control circuit 130 are provided and formed such that heat provided by the heater also increases the temperature of at least a portion of the closable branches, thereby altering their temperature-dependent total electric resistance.

This may be realized by arranging temperature-dependent resistors with different temperature-dependent resistance profiles within the different branches of the control circuit 130. Preferably, the temperature-dependent resistors are positive temperature coefficient (PTC) thermistors with different temperature-dependent resistance profiles.

With PTC thermistors, resistance increases as temperature rises, preferably in such a way that the resistance rises suddenly at a certain critical temperature which is called the Curie temperature. The thermistors may e.g. be made from doped polycrystalline ceramic (containing barium titanate (BaTiO3) and other compounds) or may be realized as polymer PTC thermistors.

In FIG. 1, a variant is illustrated in which four thermistors 135-1, 135-2, 135-3, 135-4 (designated jointly as 135-i) are coupled in electrical series. The closable branches of the control circuit 130 are coupled such to that electrical series that each closable branch of the control circuit 130 contains a different number of thermistors 135-i.

Connected in series between the electrical contact points 131-1, 131-2 of the first pair of electrical contact points (i.e. in a first closable branch of the control circuit 130) is only a first thermistor 135-1. Connected in series between the electrical contact points 132-1, 132-2 of the second pair of electrical contact points (i.e. in a second closable branch of the control circuit 130) are the first thermistor 135-1 and a second thermistor 135-2. Connected in series between the electrical contact points 133-1, 133-2 of the third pair of electrical contact points (i.e. in a third closable branch of the control circuit 130) are the first thermistor 135-1, the second thermistor 135-2 and a third thermistor 135-3. Connected in series between the electrical contact points 134-1, 134-2 of the fourth pair of electrical contact points (i.e. in a fourth closable branch of the control circuit 130) are the first thermistor 135-1, the second thermistor 135-2, the third thermistor 135-3 and a fourth thermistor 135-4.

The heater 136 and the electrical power source 137 are preferably connected between the first electrical contact points 131-1, 132-1, 133-1 134-1 of the pairs of electrical contact points on one side and the series of thermistors 135-i on the other hand, more preferably in series.

Preferably, the first through fourth thermistors 135-1, 135-2, 135-3, 135-4 are provided with increasing respective Curie temperatures T_{c,1}>T_{c,2}>T_{c,3}>T_{c,4}. Thus, when the electrically conductive pattern 152 closes the first closable branch comprising the first thermistor 135-1, thereby supplying electrical power to the heater, the heater will increase its heat output until, by the same heat output, the first thermistor 135-1 is heated up to its Curie temperature T_{c,1}. At that time, the current through the first thermistor 135-1 will decrease sharply and the heat emission will be reduced accordingly, until the temperature of the first thermistor 135-1 is reduced below its Curie temperature T_{c,1}. In this way, a simple regulation of the temperature of the consumable 150, or of the heated portion of the consumable 150, is achieved. Depending on the spatial arrangement of the consumable 150, the heater and the thermistors 135-i, the vaping temperature of the consumable 150, or the heated portion of the consumable 150, may be the same as the corresponding Curie temperature T_{c,1} or may be higher or lower.

When, as shown in FIG. 2, a consumable 150 is inserted into the receiving cavity 112 which engages with the second pair of electrical contact points 132-1, 132-2, then the electrically conductive pattern 152 closes the second closable branch comprising the second thermistor 135-2 instead. The second thermistor 135-2 has a lower Curie temperature T_{c,2} than the first thermistor 135-1, which is also part of the second branch of the control circuit 130 closed by the second pair of electrical contact points 132-1, 132-2.

Because of the lower Curie temperature T_{c,2} of the second thermistor 135-2, the heater 136 will not reach the same temperature as in the previously described case. In the same way, closing the third or the fourth branch of the control circuit 130 will include the third and fourth thermistors 135-3, 135-4, respectively, and thus lower the temperature of the heater 136, and thereby the vaping temperature, even further. In this way, the electrically conductive pattern 152 of the consumable 150 may encode, in an electromechanical way, a predetermined optimal vaping temperature for that consumable 150.

Alternatively, or additionally to the vaping temperature, other operating parameters of the electronic cigarette 100 and/or of the consumable 150 may be encoded by the electrically conductive pattern 152. For example, a colour of a light-emitting element of the electronic cigarette 100 and/or of the consumable 150 may be set based on the electrically conductive pattern 152. For example, in the embodiment shown in FIG. 1, LEDs of different colours may be provided electrically between each second electrical contact point 131-2, 132-2, 133-2, 134-2 and the respective thermistor 135-1, 135-2, 135-3, 135-4 such that, by closing a specific branch of the control circuit 130, a specific LED is also powered. The light-emitting elements may also be set in circuits separate from the heating/control circuit 130 and may be connected to the same electrical contact points 131-i, 132-i, 133-i, 134-i as the control circuit 130 and/or to other electrical contact points connectable by the electrically conductive pattern 152.

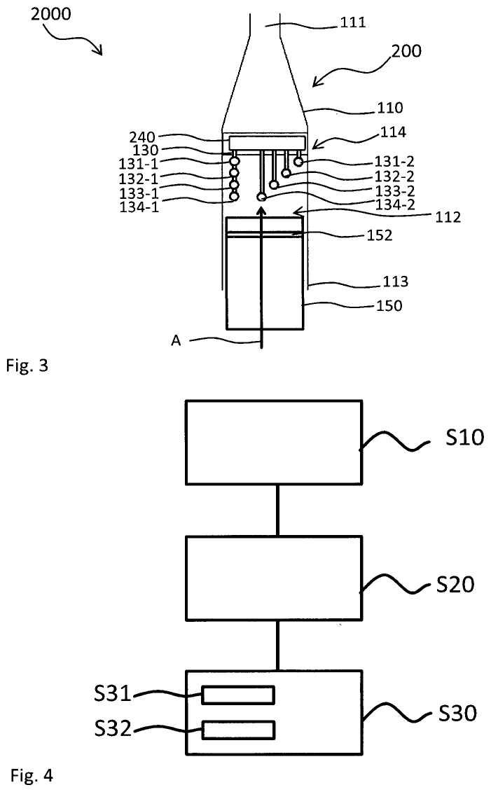

With reference to FIG. 3 of the drawings, an electronic cigarette 200 according to an embodiment of the first aspect of the present invention, and a smoking system 2000 according to an embodiment of the third aspect of the present invention are described.

The electronic cigarette 200 and the system 2000 of FIG. 3 differs from the embodiments described with respect to FIG. 1 and FIG. 2 in that the control circuit 130 of the electronic cigarette 200 comprises a controller 240 which acts as a controlling structure (instead of the thermistors 135-i), and that the smoking system 2000 comprises the electronic cigarette 200 instead of the electronic cigarette 100.

The controller 240 may be implemented as only consisting of hardware, e.g. as comprising transistors, logic gates and other circuitry. Additionally, the controller 240 may be partially realized in terms of software. As such, the controller 240 may comprise a processor and a memory storing a software or a firmware that is executed by the processor. Signals may be received by an input interlace of the controller 240 and signals that the processor of the controller 240 creates may be outputted by an output interface of the controller 240. The controller 240 may be implemented as, or using, a microcontroller, an ASIC, an FPGA and so on, optionally in combination with a non-volatile memory. The physical elements that the controller 240 consists of, or uses, may optionally be shared with other pieces of hardware or software.

The controller 240 is configured to detect which of the pairs of electrical contact points 131-i, 132-i, 133-i, 134-i is or are electrically connected by an electrically conductive pattern 152 of a consumable 150 inserted into the receiving cavity 112. In some embodiments the controller 240 may be configured to, in addition, detect if any of the pairs of electrical contact points 131-i, 132-i, 133-i, 134-i are connected by the electrically conductive pattern 152 of a consumable 150 inserted into the receiving cavity 112. In such embodiments, the controller may comprise, or receive data from, a sensor configured to determine whether a consumable 150 is currently inserted into the receiving cavity 112. That sensor may operate based on mechanical pressure, on optical measurements, on an electrical circuit being closed by the consumable 150 (e.g. by a second electrically conductive pattern in or on the consumable 150) and so on.

Based on the pattern of electrical contact points 131-i, 132-i, 133-i, 134-i detected to be connected by a particular electrically conductive pattern 152 (or, in other words, based on the electrically conductive pattern 152 of the inserted consumable 150), the controller 240 may control operating parameters of the electronic cigarette 200 and/or of the consumable 150.

In particular, the controller 240 may control any or all of the following operating parameters based on the electrically conductive pattern 152:
a heat output or a temperature of a heater of the consumable 150 and/or of the electronic cigarette 200;
a vaping temperature of the electronic cigarette 200;
a lighting scheme, in particular a colour of emitted light, of the electronic cigarette 200;
a selection of options for a user at a user interface of the electronic cigarette 200;
an operating parameter, such as pumping power, of a micropump of the electronic cigarette 200 and/or of the consumable 150;
a sound generated by a sound generator of the electronic cigarette 200.

The controller 240 may have access to, preferably comprise, a database, in which different electrically conductive patterns 152 (or, in other words, patterns of closed pairs of electrical contact points 131-i, 132-i, 133-i, 134-i) are related to settings and/or options for any or all of the controlled operating parameters. The database may be programmable and/or adjustable by a user, e.g. via a user interface of the electronic cigarette 100. There may be operating parameters that the user may adjust some or all settings for and there may be operating parameters for which the user may adjust no settings.

For example, a user may be able to program that for a consumable 150 comprising a menthol-flavoured liquid (identified by its electrically conductive pattern 152), a green light should be emitted from the electronic cigarette 100 but may be unable to change the optimal vaping temperature for said consumable 150 that has been predetermined and encoded in the database.

FIG. 4 is a schematic flow diagram illustrating a method of operating a smoking system 1000; 2000 according to a fourth aspect of the present invention, wherein the smoking system 1000; 2000 comprises an electronic cigarette 100; 200 and a consumable 150 including an electrically conductive pattern 152 provided at least partially on an outside of the consumable 150.

The method described with respect to FIG. 4 may be performed with any or all of the previously described electronic cigarettes 100; 200 and/or smoking systems 1000; 2000 and/or consumables 150. Accordingly, the method described with respect to FIG. 4 may be provided with any of the modifications, options and variations as described in the foregoing with respect to FIG. 1 to FIG. 3, and vice versa. The method will be described partially using reference signs of FIG. 1 to FIG. 3; however, the method is not restricted to the previously described electronic cigarettes, smoking systems and consumables.

In a step S10, a consumable 150 is inserted into a receiving cavity 112 of an electronic cigarette 100; 200 with an electrically conductive pattern 152 provided at least partially on an outside of the consumable 150. As has been described in the foregoing, the electrically conductive pattern 152 may preferably be provided exclusively on the outside of the consumable 150 and/or may be printed onto the consumable 150, more preferably with one of the previously described inks and in one of the previously described shapes.

In a step S20, at least one pair of electrical contact points 131-i, 132-i, 133-i, 134-i of the receiving cavity 112 of the electronic cigarette 100; 200 is contacted by the electrically conductive pattern 152, thereby closing at least one branch of a control circuit 130 of the electronic cigarette 100; 200. Preferably, exactly one pair of electrical contact points 131-i, 132-i, 133-i, 134-i is closed by the electrically conductive pattern 152.

In a step S30, at least one operating parameter of the electronic cigarette 100; 200 and/or of the consumable 150 is set based on the electrically conductive pattern 152.

Preferably, setting the at least one operating parameter includes the following sub-steps:

In an optional sub-step S31, a setting and/or an option for an operating parameter of the electronic cigarette 100 and/or of the consumable 150 may be determined based on the electrically conductive pattern 152, for example in an electromechanical manner and/or thermoelectric manner (such as with thermistors as a controlling structure) and/or in a digital manner (such as with a controller 240 as a controlling structure).

In an optional sub-step S32, at least a portion of the consumable is heated by a heater 136 of the electronic cigarette 100; 200 according to a heating profile based on which of the pairs of electrical contact points 131-i, 132-i, 133-i, 134-i has been electrically contacted by the electrically conductive pattern 152, or, in other words, based on the electrically conductive pattern 152.

The invention comprises, among others, the following embodiments:

Embodiment 1. An electronic cigarette (100; 200) comprising:

a main body (110) having a receiving cavity (112) configured to receive a removable consumable (150) comprising a substance to be vaporized, and
an electrical circuitry (114),
wherein the electrical circuitry (114) comprises a heating circuit that is connectable to a heater (136) configured to supply energy to the consumable (150) such as to vaporize the substance, and
wherein the electrical circuitry (114) comprises an open control circuit (130) comprising and connected to at least two electrical contact points (131-i, 132-i, 133-i, 134-i) arranged as a pair and configured to establish a closed electrical circuit when they are in contact with a conductive surface on the removable consumable (150), the conductive surface being separate from the heater (136).

Embodiment 2. The electronic cigarette (100; 200) according to Embodiment 1, wherein the at least two electrical contact points (131-i, 132-i, 133-i, 134-i) are located inside the receiving cavity (112).

Embodiment 3. The electronic cigarette (100; 200) according to Embodiment 1 or Embodiment 2, wherein the heating circuit and the control circuit (130) are connected in series.

Embodiment 4. The electronic cigarette (100; 200) according to Embodiment 1 or 2, wherein the heating circuit and the control circuit (130) are connected in parallel.

Embodiment 5. The electronic cigarette (100; 200) according to Embodiment 1, wherein the open control circuit (130) comprises a plurality of closable branches, and

wherein each branch of the open control circuit (130) is provided with a pair of electrical contact points (131-i, 132-i, 133-i, 134-i).

Embodiment 6. The electronic cigarette (100; 200) according to Embodiment 5, wherein a first electrical contact point and a second electrical contact point within each pair are provided at the same longitudinal position in the receiving cavity (112), and wherein the plurality of pairs are provided at different positions in the longitudinal direction of the receiving cavity (112).

Embodiment 7. The electronic cigarette (100; 200) according to Embodiment 5 or 6, wherein the branches of the electrical control circuit (130) are realized as heating circuits,

wherein the heating circuits deliver electrical energy to the heater based on an electrical resistance of the respective heating circuit.

Embodiment 8. The electronic cigarette (100; 200) according to Embodiment 7, wherein the control circuit (130) comprises, set within each of its branches, a positive temperature coefficient, PTC, thermistor, wherein each PTC thermistor has a different Curie temperature.

Embodiment 9. The electronic cigarette (100; 200) according to the preceding Embodiment, wherein each PTC thermistor is arranged to be subject to heat when the consumable (150) is being heated by the heater (136) such that the electrical resistance of the respective heating circuit depends on the temperature to which the consumable (150) is heated.

Embodiment 10. The electronic cigarette (100; 200) according to any one of Embodiments 1 to 9, wherein the heater (136) is located within the consumable (150).

Embodiment 11. The electronic cigarette (100; 200) according to any one of Embodiments 1 to 9, wherein the heater (136) is located in the main body (110) of the electronic cigarette (100; 200), preferably within the receiving cavity (112).

Embodiment 12. The electronic cigarette (200) according to any one of the preceding Embodiments 1 to 11, wherein the electrical circuitry (114) further comprises a controller (240), wherein the controller (240) is configured to sense which pair of electrical contact points (131-i, 132-i, 133-i, 134-i) is connected by a conductive surface on the consumable (150), and

wherein the controller (240) is further configured to set an operating temperature to which the heater (136) heats a portion of the consumable (150) based on which pair of the electrical contact points (131-i, 132-i, 133-i, 134-i) is connected.

Embodiment 13. The electronic cigarette (100; 200) according to the preceding Embodiment, wherein the controller (240) is configured to set different heating profiles, according to which the heater (136) heats the portion of the consumable (150).

Embodiment 14. A consumable (150) for an electronic cigarette (100; 200), the consumable (150) comprising a vaporizable substance and a housing, wherein the housing is provided with an electrically conductive pattern configured to close an open control circuit (130) in the electronic cigarette (100; 200) when contacted by a pair of at least two electrical contact points (131-i, 132-i, 133-i, 134-i) in the electronic cigarette (100; 200).

Embodiment 15. The consumable (150) according to the preceding Embodiment, wherein the electrically conductive pattern is a continuous pattern which enables the consumable (150) to close the open control circuit (130) irrespectively of the angular position of the consumable (150) in relation to the receiving cavity (112).

Embodiment 16. The consumable (150) according to Embodiment 14 or Embodiment 15, wherein the electrically conductive pattern is formed in the shape of a ring, positioned around the circumference of the consumable (150).

Embodiment 17. The consumable (150) according to any of c Embodiments 14 to 16, wherein the electrically conductive pattern is at least partially printed onto an outer layer of the consumable (150).

Embodiment 18. The consumable (150) according to any of Embodiments 14 to 17, wherein the electrically conductive pattern is printed using an ingredient selected from the group comprising graphene and metallic nanoparticle ink.

Embodiment 19. An electronic smoking system (1000; 2000), comprising the electronic cigarette (100; 200) according to any one of Embodiments 1 to 13 and a consumable (150) according to any one of Embodiments 14 to 18.

Embodiment 20. Method of operating an electronic smoking system (1000; 2000), the smoking system (1000; 2000) comprising an electronic cigarette (100; 200) and a consumable (150) including an electrically conductive pattern provided at least partially on an outside of the consumable (150), the method comprising the steps of:

inserting the consumable (150) into a receiving cavity (112) of the electronic cigarette (100; 200),
contacting, by the electrically conductive pattern, at least one pair of electrical contacts (131-i, 132-i, 133-i, 134-i) of the receiving cavity (112) of the electronic cigarette (100; 200), thereby closing at least one of different branches of a control circuit (130) of the electronic cigarette (100; 200); and
heating, by a heater (136) of the electronic cigarette (100; 200), at least a portion of the consumable (150) according to a heating profile, the heating profile being selected based on which one of the branches of the control circuit (130) of the electronic cigarette (100; 200) has been closed.

Although specific embodiments of the invention are illustrated and described herein, it will be appreciated by those of ordinary skill in the art that a variety of alternate and/or equivalent implementations exist. It should be appreciated that the exemplary embodiment or exemplary embodiments are examples only and are not intended to limit the scope, applicability, or configuration in any way. Rather, the foregoing summary and detailed description will provide those skilled in the art with a convenient road map for implementing at least one exemplary embodiment, it being understood that various changes may be made in the function and arrangement of elements described in an exemplary embodiment without departing from the scope as set forth in the appended claims and their legal equivalents. Generally, this application is intended to cover any adaptations or variations of the specific embodiments discussed herein.

It will also be appreciated that in this document the terms “comprise”, “comprising”, “include”, “including”, “contain”, “containing”, “have”, “having”, and any variations thereof, are intended to be understood in an inclusive (i.e. non-exclusive) sense, such that the process, method, device, apparatus or system described herein is not limited to those features or parts or elements or steps recited but may include other elements, features, parts or steps not expressly listed or inherent to such process, method, article, or apparatus. Furthermore, the terms “a” and “an” used herein are intended to be understood as meaning one or more unless explicitly stated otherwise. Moreover, the terms “first”, “second”, “third”, etc. are used merely as labels, and are not intended to impose numerical requirements on or to establish a certain ranking of importance of their objects.

### LIST OF DRAWING SIGNS

100 electronic cigarette
110 main body
111 mouthpiece
112 receiving cavity
113 opening
114 electrical circuitry
130 control circuit
131-i electrical contact point
132-i electrical contact point
133-i electrical contact point
134-i electrical contact point
135-i thermistor
136 heater
137 electrical power source
150 consumable
152 electrically conductive pattern
200 electronic cigarette
240 controller
1000 electronic smoking system
2000 electronic smoking system
S10-S30
   method steps
S31, S32
   method sub-steps

1. An electronic cigarette comprising:
a main body having a receiving cavity configured to receive a removable consumable comprising a substance to be vaporized, and
an electrical circuitry,
wherein the electrical circuitry comprises a heating circuit that is connectable to a heater configured to supply energy to the consumable, and
wherein the electrical circuitry further comprises an open control circuit comprising and connected to at least two electrical contact points arranged as a pair and configured to establish a closed electrical circuit when the at least two electrical contact points are in contact with a conductive surface on the removable consumable, the conductive surface being separate from the heater, wherein the open control circuit comprises a plurality of closable branches,
wherein each branch of the plurality of closable branches of the open control circuit is provided with a pair of the at least two electrical contact points,
wherein the electrical circuitry further comprises a controller, wherein the controller is configured to sense which pair of electrical contact points is connected by a conductive surface on the consumable, and
wherein the controller is further configured to set an operating temperature to which the heater heats a portion of the consumable based on which pair of the electrical contact points is connected.

2. The electronic cigarette according to claim 1, wherein the at least two electrical contact points are located inside the receiving cavity.

3. The electronic cigarette according to claim 1, wherein the heating circuit and the open control circuit are connected in series.

4. The electronic cigarette according to claim 1, wherein the heating circuit and the open control circuit are connected in parallel.

5. The electronic cigarette according to claim 1,
wherein a first electrical contact point and a second electrical contact point within each pair are provided at the same longitudinal position in the receiving cavity, and wherein the pairs are provided at different positions in a longitudinal direction of the receiving cavity.

6. The electronic cigarette according to claim 5, wherein the plurality of closable branches of the open control circuit are heating circuits,
wherein the heating circuits deliver electrical energy to the heater based on an electrical resistance of the respective heating circuit.

7. The electronic cigarette according to claim 6, wherein the open control circuit comprises, set within each of the plurality of closable branches, a positive temperature coefficient thermistor, wherein each positive temperature coefficient thermistor has a different Curie temperature.

8. The electronic cigarette according to claim 7, wherein each positive temperature coefficient thermistor is arranged to be subject to heat when the consumable is being heated by the heater such that the electrical resistance of the respective heating circuit depends on a temperature to which the consumable is heated.

9. The electronic smoking system according to claim 12, further comprising a heater located within the consumable.

10. The electronic cigarette according to claim 1, further comprising a heater located in the main body of the electronic cigarette.

11. The electronic cigarette according to claim 1, wherein the controller is configured to set different heating profiles, according to which the heater heat the portion of the consumable.

12. An electronic smoking system comprising the electronic cigarette according to claim 1 and further comprising a consumable for the electronic cigarette, the consumable comprising a vaporizable substance and a housing, wherein the housing is provided with an electrically conductive pattern configured to close the open control circuit in the electronic cigarette when contacted by a pair of the at least two electrical contact points in the electronic cigarette.

13. The electronic smoking system according to claim 12, wherein the electrically conductive pattern is a continuous pattern which enables the consumable to close the open control circuit irrespectively of an angular position of the consumable in relation to the receiving cavity.

14. The electronic smoking system according to claim 12, wherein the electrically conductive pattern is formed in a shape of a ring, positioned around a circumference of the consumable.

15. The electronic smoking system according to claim 12, wherein the electrically conductive pattern is at least partially printed onto an outer layer of the consumable.

16. The electronic smoking system according to claim 12, wherein the electrically conductive pattern is printed using graphene and/or metallic nanoparticle ink.

17. A method of operating an electronic smoking system, the smoking system comprising an electronic cigarette and a consumable including an electrically conductive pattern provided at least partially on an outside of the consumable, the method comprising the steps of:
inserting the consumable into a receiving cavity of the electronic cigarette,
contacting, by the electrically conductive pattern, at least one pair of electrical contacts of the receiving cavity of the electronic cigarette, thereby closing at least one of different branches of a control circuit of the electronic cigarette; and
heating at least a portion of the consumable according to a heating profile, the heating profile being selected based on which one of the branches of the control circuit of the electronic cigarette has been closed.

18. The electronic cigarette according to claim 10, wherein the heater is located within the receiving cavity.
